(19) United States
(12) Patent Application Publication
(10) Pub. No.: US 2009/0097502 A1
(43) Pub. Date: Apr. 16, 2009

(54) Field equipment control system

(75) Inventor: Shuji Yamamoto, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/920,317

(22) PCT Filed: May 11, 2006
(86) PCT No.: PCT/JP2006/309476

§ 371 Date: Nov. 13, 2007

(30) Foreign Application Priority Data
May 12, 2005 (JP) 2005-139256

(51) Int. Cl. H04J 3/22

(52) U.S. Cl. 370/466

(57) ABSTRACT

A field equipment control system including: a plurality of field equipments installed in a field; and a control device for controlling the plurality of field equipments, wherein each of the field equipments has a wireless communication section for transmitting/receiving data between the field equipments, and at least one field equipment out of the plurality of field equipments, which is connected to the control device, has a communication relaying section for carrying out a data conversion between different protocols.

### TECHNICAL FIELD

The present invention relates to a field equipment control system for gathering physical information on a building, a factory equipment, and a natural environment in Industrial Automation (IA), Factory Automation (FA) or the like and, more particularly, a field equipment control system using a wireless network.

### BACKGROUND ART

In the field equipment control system used in process control or the like, the control sensor unit or the control unit is installed in advance in major locations such as controlling points, controlling/measuring points or the like, and a system design that permits executing a desired control exactly is adopted.

In such a process control, for the purpose of system maintenance, the observing/maintaining units are arranged at important points of the system to detect whether or not any equipment is deteriorated in the system, whether or not any abnormality is caused in the equipment operation, or whether or not any sign of abnormality appears.

The worker goes round the field periodically to check the equipments, so that measured data of these observing/maintaining units are gathered as the data to maintain/diagnose the operation history, etc., of the equipments.

Namely, the control unit and the control sensor unit are on-line connected to the Operation Pilot Station (OPS) to cooperate with the controlling system, nevertheless the data acquisition from the observing/maintaining units is the off-line work that relies on the human labor.

FIG. 4 is a configuration view showing an example of the field equipment control system in the related-art.

In FIG. 4, an operation pilot station (OPS) 1 is equipped with an operating section, a display section, a control program, a database, and the like (all not shown). The OPS 1 monitors operating conditions of the plant, or changes the settings of the plant.

A field control station (FCS) 2 is connected to the OPS 1 via a control bus 6 and is connected to control units 43 and control sensor units 44 such as flowmeters, and the like via a field bus 7. For example, in the process control, the FCS 2 senses signals from the flowmeters based on the control program downloaded from the OPSI or the database, and controls openings of the valves.

Each of observing/maintaining units 45a to 45e has sensor sections such as a temperature sensor, a pressure sensor, a vibration sensor, etc., a control section for processing the arithmetic operation, etc. of sensed results, and a display section for displaying the result, and the like. The observing/maintaining units 45a to 45e measure a temperature, a pressure, a vibration, etc. of a tank 8, pipes 9a, 9b, etc., and store the data in a memory in the system.

When the worker goes round the field periodically to check the equipments, the data of these observing/maintaining units are manually read/recorded.

In addition, there has been proposed a field equipment control system such that a communication section for establishing a communication between a handy terminal and the FCS via cable or wireless is provided in the FCS, and then the data are gathered from an observing sensor by the handy terminal via the FCS serving as a wireless fixed station when the worker goes round the equipped location of the FCS (see Patent Document 1, for example).

Meanwhile, the field equipment control system using a wireless communication has been proposed (see Patent Document 2, for example).

FIG. 5 is a configuration view showing another example of a field equipment control system in the related-art.

In FIG. 5, the process control based upon the control units such as the OPSs, the FCSs, the valves, etc. and the control sensor units such as the flowmeters, etc. is same as that in the foregoing drawing, and therefore their explanation will be omitted herein.

A control unit 53, a control sensor unit 54, observing/maintaining units 55a to 55j have a wireless communication section respectively. As indicated with a broken line arrow, respective units transmit their own measured data to relay stations 56a to 56c, and then the measured data are transferred to an administration station 57 connected to the relay stations via cable.

Patent Document 1: Japanese Unexamined Patent Publication JP-A-5-175902

Patent Document 2: Japanese Unexamined Patent Publication JP-T-10-508129

### DISCLOSURE OF THE INVENTION

### Problems that the Invention is to Solve

In such field equipment control system, the data collected manually for the purpose of maintenance are not on-line connected to the process control system. Therefore, the work for inputting the data into the system is needed after the data collection.

Because the data are not on-line supplied from the observing sensors, a sudden status change of the equipment cannot be sensed in real time. In some cases, the measure for the abnormality or the defect of the equipment is never taken in time.

Also, because the data are gathered manually, the number of the observing points in the field cannot be increased without limit. That is, a limit of the observing points is decided based on the number of workers and a checking frequency. The presence of the limit in the observing points brings about a situation that the locations that are to be observed but actually cannot be observed are present. Therefore, an accuracy of maintenance/diagnosis is lowered.

In addition, it is difficult to monitor an age-based change of the plant equipment, etc., from which observation data must be collected for a predetermined term at a predetermined frequency in a predetermined geographic area.

In order to deal with the above-described problems, the data may also be on-line collected from the observing sensors. However, when many sensors, FCSs, etc., should be connected via cable, there are restrictions as to a communication distance, a wire laying space, and the like.

Also, when the data of respective field equipments are acquired from the OPSs by using wireless communication, a strong wireless wave is needed in the wide-area plant. Therefore, there are such problems that the electromagnetic interference with electronic circuits such as the high-resolution sensor, etc. is caused, the measure for the explosion protection that needs to emit an electromagnetic wave with a smaller energy becomes difficult, and the like.

On the contrary, according to the system where a plurality of field equipments transmit the data of each equipment to the center control area via the relay station, a data transmission with a weak wireless wave can be realized. In this event, the data collected via wireless are handled by another system that is different from the process controlling system. Therefore, in order to correlate the collected data with the process controlling system consisting of the OPCs and the FCSs, a new function is required of the OPC and the FCS. Otherwise, a new integrated system is required as an upper system of the OPC and the FCS.

Also, there is such a problem that, in order to connect to the control station, nodes used for relaying the data from the equipments that are unevenly distributed in the field must be provided.

The present invention provides a field equipment control system capable of collecting data for use in observation, maintenance, etc. in real time without manual assistance and also causing the control device to cooperate with observing/maintaining units as it is without replacement, by providing a communication relaying section, which carries out a data conversion between different protocols, to at least one field equipment out of a plurality of field equipments, which is connected to a control device.

### Means for Solving the Problems

A field equipment control system, includes:

a plurality of field equipments installed in a field; and

a control device for controlling the plurality of field equipments,

wherein each of the field equipments has a wireless communication section for transmitting/receiving data between the field equipments, and

at least one field equipment out of the plurality of field equipments, which is connected to the control device, has a communication relaying section for carrying out a data conversion between different protocols.

According to the field equipment control system of the present invention, at least one field equipment out of the plurality of field equipments has a router function for transmitting data to a designated node via an optimal route.

According to the field equipment control system of the present invention, the communication relaying section establishes at least one network out of a mesh topology, a cluster topology, a tree topology, and a star topology.

According to the field equipment control system of the present invention, the field equipment has an identifier by which the control device identifies the field equipment.

According to the field equipment control system of the present invention, the field equipment has a communication section for establishing a communication with a mobile terminal via cable or wireless.

According to the field equipment control system of the present invention, the wireless communication section is provided by connecting a wireless node to the field equipment already provided to the field equipment control system.

### ADVANTAGES OF THE INVENTION

According to the present invention, following advantages can be achieved.

According to the field equipment control system of the present invention, the observation/maintenance data, etc., can be transmitted to the FCS and the OPS via the field bus. Also, the commands can be transmitted from the OPS and the FCS to the field equipments used for purposes of observation/maintenance.

Therefore, the existing infrastructures such as the OPS, the FCS, etc., can be utilized without manual assistance, a new wire and a new communication equipment, etc.

According to the field equipment control system of the present invention, the field worker can establish a communication with the target field equipment, the OPS, and the FCS via the nearest field equipment by using the mobile terminal. Thus, the field worker can operate the target equipment, etc. or monitor the information of them.

According to the field equipment control system of the present invention, when the wireless node is connected to the existing field equipment, the equipments that have already been provided to the field can be changed in accordance with a wireless communication at the minimum man-hour and cost.

### BRIEF DESCRIPTION OF THE DRAWINGS

FIG. 1 is a configuration view showing a first embodiment of a field equipment control system according to the present invention;

FIG. 2 is a configuration view showing an embodiment of the field equipment used in FIG. 1;

FIG. 3 is a configuration view showing a second embodiment of a field equipment control system according to the present invention;

FIG. 4 is a configuration view showing an example of a field equipment control system in the related-art; and

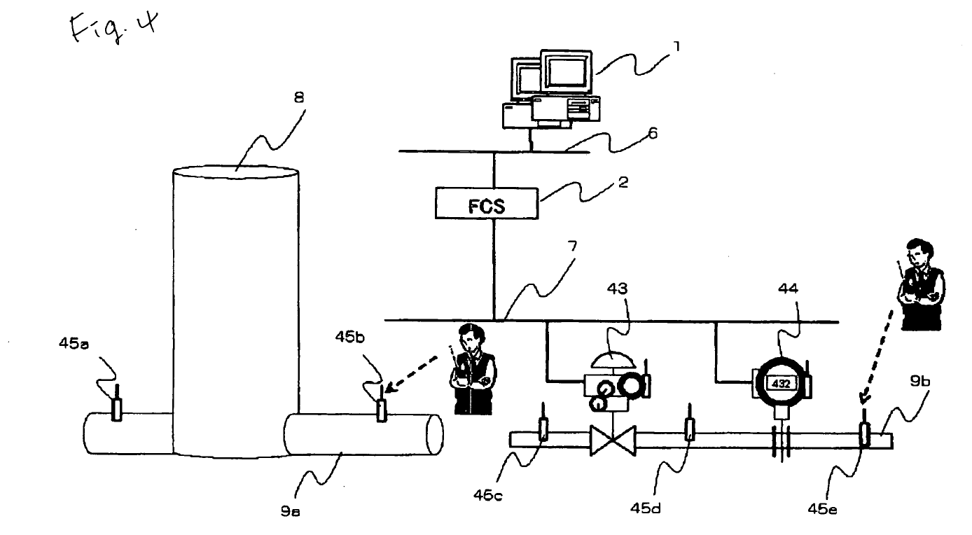

FIG. 5 is a configuration view showing another example of a field equipment control system in the related-art.

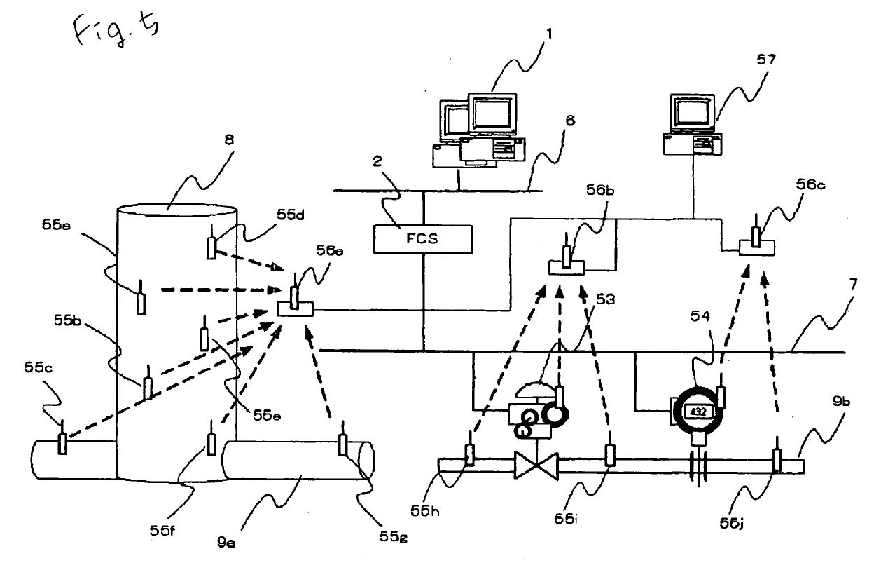

### DESCRIPTION OF REFERENCE NUMERALS AND SIGNS

1 operation pilot station (OPS)
2 field control station (FCS)
3 control device
4 control sensor unit
5a to 5j observing/maintaining units
6 control bus
7 field bus
20 field equipment
21 wireless communication section
22 communication relaying section
23 address storing section
24 control section
30 mobile terminal

### BEST MODE FOR CARRYING OUT THE INVENTION

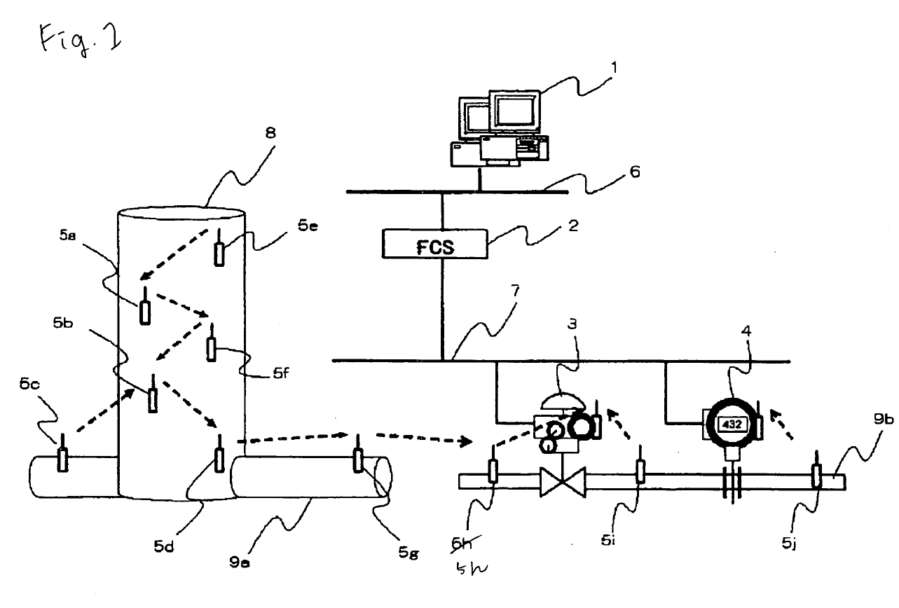

The present invention will be explained in detail with reference to the drawings hereinafter. FIG. 1 is a configuration view showing a first embodiment of a field equipment control system according to the present invention.

In FIG. 1, explanations of sections associated with the process control executed by control devices 3 such as the OPS 1, the FCS 2, the valve, etc., and control sensor units 4 such as the flowmeter, etc. are same as those in the foregoing Figures. Therefore, their explanations will be omitted herein.

In FIG. 1, each of the field equipments such as the control device 3, the control sensor unit 4, observing/maintaining units 5a to 5j, etc. has a wireless communication function. The control device 3 and the control sensor unit 4 are the field equipment for performing the process control, and are controlled by the FCS 2 via the field bus 7. The FCS 2 is connected to the OPS 1 via the control bus 6. Thus, the overall process control is performed and managed by the OPS 1. Here, the OPS 1 and the FCS 2 correspond to the control device.

The observing/maintaining units 5a to 5j are observing sensors, for example. The observing/maintaining units 5a to 5j measure a temperature, a pressure, a vibration, etc. of the tank 8, the pipes 9a, 9b, etc. and accumulate the data. Also, the observing/maintaining units 5a to 5j transmit the data to the field equipments such as the control device 3, the control sensor unit 4, and the like, which are connected to the FCS 2 via the field bus 7, via wireless communication.

With this arrangement, the data such as maintenance data, and the like, which have been gathered manually up to now via the separate system and have no effect on the essential process control, can also be on-line collected into the existing FCS 2 and the existing OPS 1.

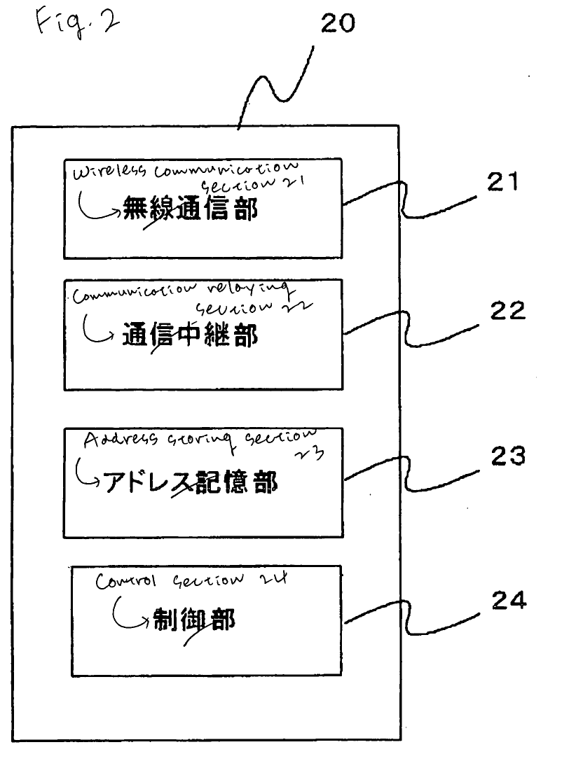

Such field equipment will be explained in detail with reference to FIG. 2 as described below.

FIG. 2 is a configuration view showing an embodiment of the field equipment used in FIG. 1.

In this case, the present invention can be adapted to the overall field equipments. Also, in FIG. 2, for convenience of explanation, functional blocks such as a display section, an operating section will be omitted hereunder.

In FIG. 2, each of field equipments 20 such as the control device 3, the control sensor unit 4 and the observing/maintaining units 5a to 5j has a wireless communication section 21, a communication relaying section 22, an address storing section 23, and a control section 24.

The wireless communication section 21 is composed of a wireless module, or the like. The wireless communication section 21 transmits the measured data via wireless communication, and receives a command from the OPS 1, FCS 2, and the like. The setting of the field equipment, for example, is changed by this command.

The communication relaying section 22 corresponds to the ad hoc network, for example, and has a communication relaying function for the multihopping, as indicated with a broken arrow in FIG. 1.

Also, the communication relaying section 22 has a router function for deciding a destination in the hopping.

In the field equipment not connected to the OPS 1 and the FCS 2, this router function transfers the data and the command toward the field equipment connected to the OPS 1 and the FCS 2. Also, the data can be transferred between the OPS or the FCS and the designated node (field equipment) via the optimal route in compliance with the route control protocol.

In this case, this router function may be installed into all field equipments. Otherwise, this router function may not be installed into the field equipment that is provided at the end of the field and is not required to point the communication route, for example.

Further, the optimal network can be built up by supporting the topology such as a star topology, a mesh topology, a cluster topology, a tree topology, or the like

In this event, the communication relaying section 22 of the field equipment 20 connected to the FCS 2 via the field bus 7 has a relay function for converting communication data between different protocols. This relay function is used to either transmit the data received from other field equipments to the FCS 2 connected by the field bus 7 or transmit the data sent from the FCS 2 to other field equipments.

As a concrete example, when the field bus is Local Area Network (LAN), Internet Protocol (IP) is used, and different protocols such as ZigBee, and the like are used as wireless, a mutual connectivity between different protocols can be realized by installing a gateway function for protocol conversion into the communication relaying section 22.

In this event, the field equipments connected to the FCS and the OPS may be connected via cable in some cases or the field equipments may be connected via wireless in other cases.

Also, when the equipment connected to the FCS and the OPS is a field controller, such gateway function may be installed into the field controller. Alternately, such gateway function may be installed into a dedicated gateway unit provided separately.

The address storing section 23 stores an address by which an individual unit of the field equipments 20 can be identified. This address is the unique network address in the network, and assigned automatically or manually and stored in the address storing section 23.

Also, the address storing section 23 stores the address to correlate it with an application ID (identifier) being set by the worker. The application can access respective field equipments using the identifier such as the network address, the application ID as a clue, and can manage and operate the field equipments.

Also, in case where there is no necessity to specify the equipment and a predetermined area where the equipment is provided can be specified merely, the application ID is not always needed and only the network address can be uses as the identifier.

The control section 24 obtains a detected signal of the sensor section (not shown), and converts the signal into digital data. Also, the control section 24 generates measured data by applying an arithmetic process, etc. In the case of the control unit, the control section 24 controls the valves (not shown), and the like based on the command from the OPS and the FCS in the system controlling system.

Also, the control section 24 controls the storing of the network and the application ID into the address storing section 23.

Respective sections as described above are implemented by a combination of the Central Processing Unit (CPU) (not shown) and the software, the wireless communication module used for wireless transmission/reception, the I/O module for exchanging the signal with the valve and the sensor, and the like. Also, the address storing section 23 is a memory, or the like.

As described above, the data such as the observation/maintenance data, and the like, which are not always needed, can be transmitted to the FCS 2 and the OPS 1 via the field bus 7. Also, the commands from the OPS and the FCS can be transmitted to the field equipments used for purposes of observation/maintenance.

In addition, the existing infrastructures such as the OPS 1, the FCS 2, etc. can be utilized without manual assistance, a new wire and a new communication equipment, etc.

Also, the field equipment that exists out of an available range of a wireless wave emitted from the field equipment connected to the FCS 2 transmits the data to other field equipment installed in the neighborhood. The other field equipment relays the data of the field equipment located out of the available range and transmits the data to the field equipment connected to the FCS 2, so that the data can be transmitted to the FCS and the OPC via the field bus 7.

In this case, there is no need that the field equipments such as the control unit, the control sensor unit, the observing/maintaining unit, and the like should have the wireless communication section from the beginning. For example, the wireless node may be provided via an external I/O such as a serial interface, or the like. In this case, the software in accordance with the wireless node may be provided in advance in the existing field equipment, or a function of updating (downloading) the software via communication may be added to the existing field equipment.

According to the arrangement, the equipments that have already been provided to the field can be changed in accordance with a wireless communication at a minimum man-hour and cost.

As described above, only when necessary sensors, controllers are provided in the field without the provision of new communication equipments such as the wire, the information collecting terminal, the information transmitting relay, and the like, neighboring information of the already-fitted field equipments can be collected to the center via the field equipments connected the network in the existing field.

In this case, the address to be identified on the network may be preset in the newly provided field equipments, or such address may be assigned to the newly provided field equipments by a function of assigning the address automatically. Also, the address allocation function may be provided to at least one of the equipments that are installed in the field.

As described above, the works that are carried out manually in the field equipment control system in the related-art can be performed in real time. Therefore, the data can be detected in real time and also the field equipments can be controlled in real time. Also, a temperature area, a gas area, a narrow/high area, etc. where the human work is difficult can be monitored.

Concretely, even though many field equipments are provided to detect a diffusing situation of gas leak, liquid leak, sound leak, steam leak, etc. over a wide area, the system for executing an alarm detection can be built up without limitation of the wires.

Also, the monitoring of an age-based change of the plant equipment, etc.,—from which the observation data must be collected for a predetermined term at a predetermined frequency in a predetermined geographic area—can be made easily. In addition, since the data are transmitted via the transit operation, the wireless communication can be established in a power saving mode and thus this controlling system can deal with the explosion protection.

The information collecting function does not access the essential function of the sensor and the controller in the field. Therefore, field information can be collected not to exert an influence upon the proper operations.

The observing point at a location that a wireless wave does not directly reach from the field equipment can be observed by providing a plurality of relay points. That is, a necessary area can be covered even when the number of field equipments that relay the data of the wireless sensor device is small.

Also, the command issued from the center equipment to set the operation of the wireless sensor device is relayed to the field equipment connected to the network in the field. Therefore, such command can be delivered to the target wireless sensor device.

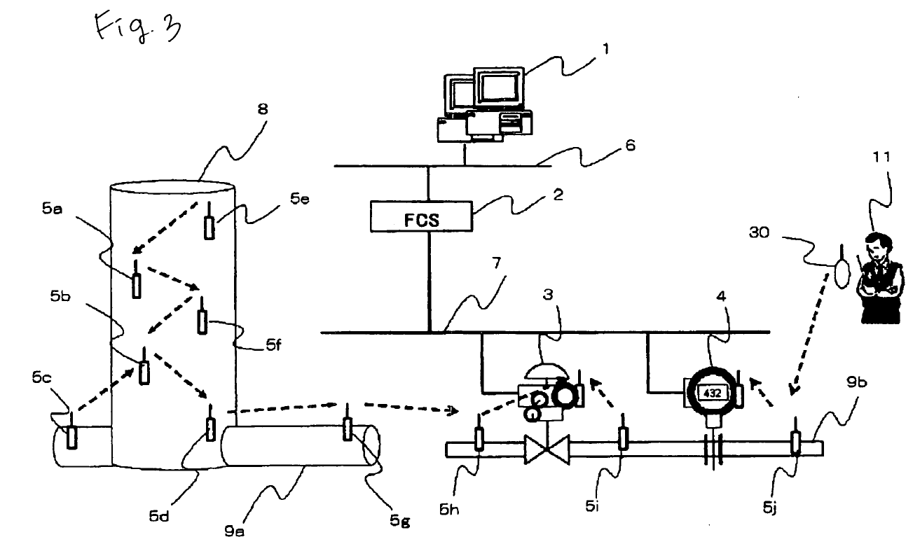

FIG. 3 is a configuration view showing a second embodiment of a field equipment control system according to the present invention.

In FIG. 3, a mobile terminal 30 held by a field worker 11 has a communication section for establishing a communication with the field equipment while utilizing the system described in FIG. 1. The field worker 11 can establish a communication with the target field equipment via the nearest field equipment (5j in FIG. 3) by instructing the ID of the field equipment on the mobile terminal 30. The field worker 11 can operate the target equipment out of the field equipments (5a to 5j), or monitor the information of the field equipment. Here, the mobile terminal is Personal Computer (PC), a cellular phone, Personal Digital Assistance (PDA), or the like.

In addition, the operator can access the control information on the OPS, the manual of the equipment, and various other information by using the field equipment as the relay station.

In the field equipment control system in the related-art, in order to access these information on the OPS, the existing communication line must be used, a new communication line must be laid, or the like. In contrast, in the present invention, the existing infrastructure can be utilized.

The present invention is not limited to the above-described embodiments, and contains further many variations and modifications within a scope that does not depart from the essence.

For example, in the above embodiments, while there has been described the case where the FCS is provided, the OPS may access directly the field equipment using the computer.

Also, in the above embodiments, the field equipment used in the process control is illustrated. In addition, the equipment installed in physical information of the natural environment is also contained in a scope of the field equipment.

This application is based on Japanese Patent Application (Patent Application No. 2005-139256) filed on May 12, 2005, the entire contents of which are incorporated herein by reference.

1. A field equipment control system, comprising:
a plurality of field equipments installed in a field; and
a control device for controlling the plurality of field equipments,
wherein each of the field equipments has a wireless communication section for transmitting/receiving data between the field equipments, and
at least one field equipment out of the plurality of field equipments, which is connected to the control device, has a communication relaying section for carrying out a data conversion between different protocols.

2. The field equipment control system according to claim 1, wherein
at least one field equipment out of the plurality of field equipments has a router function for transmitting data to a designated node via an optimal route.

3. The field equipment control system according to claim 1, wherein the communication relaying section establishes at least one network out of a mesh topology, a cluster topology, a tree topology, and a star topology.

4. The field equipment control system according to claim 1, wherein the field equipment has an identifier by which the control device identifies the field equipment.

5. The field equipment control system according to claim 1, wherein the field equipment has a communication section for establishing a communication with a mobile terminal via cable or wireless.

6. The field equipment control system according to claim 1, wherein the wireless communication section is provided by connecting a wireless node to the field equipment already provided to the field equipment control system.
